(19) United States
(12) Patent Application Publication
(10) Pub. No.: US 2021/0331697 A1
(43) Pub. Date: Oct. 28, 2021

(54) TRAVEL CONTROL DEVICE, INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventors: Takahiro HARADA, Chiryu-shi (JP); Teppei NISHIGUCHI, Nisshin-shi (JP); Kazuki KOMORIYA, Toyota-shi (JP); Tomoaki IHARA, Toyota-shi (JP); Miyu HIGASHIMURA, Toyota-shi (JP); Toshihiro NAKAICHI, Nagoya-shi (JP); Kazunobu OKASAKA, Toyota-shi (JP); Ryo HATTORI, Kariya-shi (JP); Yohei TANIGAWA, Toyota-shi (JP); Ryohei KIMBARA, Toyota-shi (JP); Hiroshi NAKAMURA, Nagoya-shi (JP)

(73) Assignee: TOYOTA JIDOSHA KABUSHIKI KAISHA, Toyota-shi (JP)

(21) Appl. No.: 17/157,074

(22) Filed: Jan. 25, 2021

(30) Foreign Application Priority Data
Apr. 27, 2020 (JP) 2020-078029

(51) Int. Cl. B60W 60/00; B60W 30/165; G01C 21/34; G08G 1/00

(52) U.S. Cl. CPC B60W 60/005; B60W 30/165; G01C 21/3453; B60W 2556/65; G08G 1/22; G08G 1/20; B60W 2556/50; B60W 60/001

(57) ABSTRACT

A travel control device controls traveling of a vehicle of which a traveling function can be switched between an autonomous traveling function and a following traveling function. The travel control device includes a control unit configured to detect, when the vehicle is traveling by the autonomous traveling function, another vehicle present within a predetermined range of the vehicle and of which any part or all of a planned travel route is partially or wholly the same as a planned travel route of the vehicle, and switch the traveling function of the vehicle from the autonomous traveling function to the following traveling function such that the vehicle autonomously follows the other vehicle detected as a leading vehicle.

### CROSS-REFERENCE TO RELATED APPLICATION

This application claims priority to Japanese Patent Application No. 2020-078029 filed on Apr. 27, 2020, incorporated herein by reference in its entirety.

### BACKGROUND

### 1. Technical Field

The present disclosure relates to a travel control device, an information processing apparatus, and an information processing method.

### 2. Description of Related Art

Japanese Unexamined Patent Application Publication No. 08-192662 (JP 08-192662 A) discloses a travel control device for a vehicle. The travel control device described in JP 08-192662 A includes a following travel control unit configured to measure an inter-vehicle distance to a leading vehicle by a vehicle-to-vehicle measuring unit and control a vehicle speed such that the measured inter-vehicle distance becomes a predetermined distance, and a constant-speed travel control unit configured to travel at a preset vehicle speed when a leading vehicle cannot be found. Moreover, the travel control device further includes an operation switch that outputs a start command signal for initiating following travel control and constant-speed travel control, a first vehicle speed setting unit configured to set the preset vehicle speed to be a vehicle speed when the start command signal is output during the constant-speed travel control, and a second vehicle speed setting unit configured to set the setting speed to be a predetermined value larger than the vehicle speed when the start command signal is output during the following travel control.

### SUMMARY

The present disclosure provides a technology for reducing an arithmetic load for traveling of a vehicle, in a travel control device that controls traveling of the vehicle.

A travel control device according to a first aspect of the present disclosure controls traveling of a vehicle of which a traveling function can be switched between an autonomous traveling function and a following traveling function. The travel control device includes a control unit configured to detect, when the vehicle is traveling by the autonomous traveling function, another vehicle present within a predetermined range of the vehicle and of which any part or all of a planned travel route is partially or wholly the same as a planned travel route of the vehicle, and switch the traveling function of the vehicle from the autonomous traveling function to the following traveling function such that the vehicle autonomously follows the detected other vehicle as a leading vehicle.

An information processing apparatus according to a second aspect of the present disclosure manages, using a travel control device, traveling of a vehicle of which a traveling function can be switched between an autonomous traveling function and a following traveling function. The information processing apparatus includes a control unit configured to detect, when the vehicle is traveling by the autonomous traveling function, another vehicle that is present within a predetermined range of the vehicle and of which any part or all of a planned travel route is partially or wholly the same as a planned travel route of the vehicle, and transmit, to the travel control device, first command information to command the travel control device to switch the traveling function of the vehicle from the autonomous traveling function to the following traveling function such that the vehicle autonomously follows the detected other vehicle as a leading vehicle.

An information processing method according to a third aspect of the present disclosure is executed by a computer included in a system including a travel control device that controls traveling of a vehicle of which a traveling function can be switched between an autonomous traveling function and a following traveling function. The information processing method includes a step of detecting, when the vehicle is traveling by the autonomous traveling function, using the travel control device, another vehicle present within a predetermined range of the vehicle and of which any part or all of a planned travel route is partially or wholly the same as a planned travel route of the vehicle, and a step of switching the traveling function of the vehicle from the autonomous traveling function to the following traveling function such that the vehicle autonomously follows the detected other vehicle as a leading vehicle.

With the present disclosure, it is possible to reduce an arithmetic load for traveling of a vehicle, in a travel control device that controls traveling of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a travel control system according to a first embodiment;

FIG. 2 is a block diagram schematically illustrating one example of a functional configuration of a travel control device and an in-vehicle device, constituting the travel control system according to the first embodiment;

FIG. 3 is a diagram illustrating one example of a situation in which a vehicle and another vehicle are traveling;

FIG. 4 is a diagram illustrating one example of a state in which a traveling function of a host vehicle traveling by an autonomous traveling function is switched to an autonomous following function with the other vehicle as a leading vehicle;

FIG. 5 is a flowchart of a first switching process;

FIG. 6 is a flowchart of a second switching process;

FIG. 7 is a diagram illustrating a schematic configuration of a travel control system according to a second embodiment;

FIG. 8 is a block diagram schematically illustrating one example of a functional configuration of a travel control device, an in-vehicle device, and a management server, constituting the travel control system according to the second embodiment;

FIG. 9 is a flowchart of a first command process; and

FIG. 10 is a flowchart of a second command process.

### DETAILED DESCRIPTION OF EMBODIMENTS

A travel control device according to the first aspect of the present disclosure is a device that controls traveling of a vehicle, which is capable of switching a traveling function of the vehicle between an autonomous traveling function and a following traveling function. The autonomous traveling function is a function in which a vehicle autonomously travels without being controlled by a person. Further, the following traveling function is a function in which the vehicle travels by autonomously following a leading vehicle. When the vehicle is traveling by the autonomous traveling function, the travel control device needs to process various pieces of information in order to realize the autonomous travel. On the other hand, when the vehicle autonomously follows the leading vehicle by the following traveling function, an amount of information processed by the travel control device is less than when the vehicle autonomously travels. Consequently, when the vehicle autonomously follows the leading vehicle, an arithmetic load in the travel control device for causing the vehicle to travel is smaller than when the vehicle autonomously travels.

In the travel control device according to the first aspect of the present disclosure, a control unit detects another vehicle present around the vehicle (host vehicle) when the vehicle is traveling by the autonomous traveling function. At this time, another vehicle is detected which is present within a predetermined range of the vehicle and of which any part or all of a planned travel route is partially or wholly the same as a planned travel route of the vehicle. The control unit switches the traveling function of the vehicle from the autonomous traveling function to the following traveling function such that the vehicle autonomously follows the detected other vehicle as the leading vehicle. Accordingly, when there is another vehicle around the vehicle which the vehicle can autonomously follow as the leading vehicle, it is possible to prioritize the vehicle traveling using the following traveling function over the autonomous traveling function. Consequently, it is possible to reduce the arithmetic load for traveling of a vehicle in the travel control device.

Hereinafter, specific embodiments of the present disclosure will be described referring to the drawings. The technical scope of the present disclosure is not limited to dimensions, materials, shapes, and relative arrangements of the components described in the present embodiment unless otherwise specified.

### First Embodiment

Outline of System

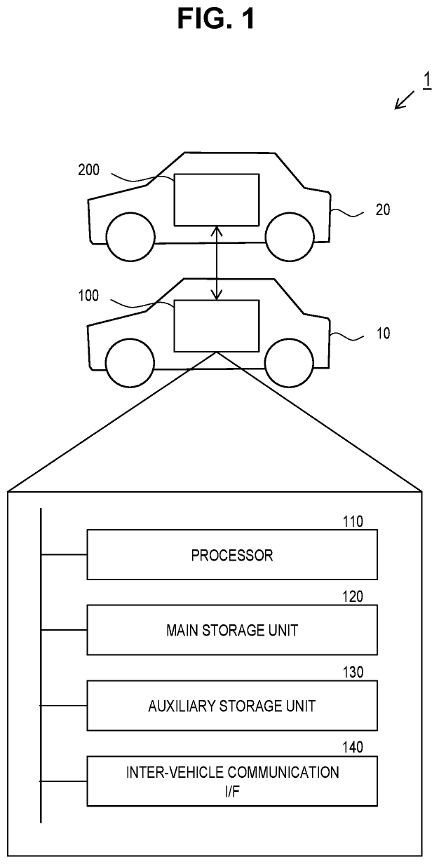

A travel control system 1 of the present embodiment will be described hereinbelow referring to FIG. 1. FIG. 1 is a diagram illustrating a schematic configuration of the travel control system 1 according to the present embodiment. The travel control system 1 includes a travel control device 100 mounted on a host vehicle 10 and an in-vehicle device 200 mounted on another vehicle 20. Further, the travel control device 100 and the in-vehicle device 200 can directly communicate with each other so as to establish inter-vehicle communication between the host vehicle 10 and the other vehicle 20.

The host vehicle 10 is a vehicle capable of switching the traveling function between the autonomous traveling function and the following traveling function. The following traveling function is a function in which the vehicle autonomously follows the leading vehicle as an inter-vehicle distance between the host vehicle 10 and the leading vehicle is maintained. The host vehicle 10 in the present embodiment corresponds to the “vehicle” of the present disclosure. The other vehicle 20 is a vehicle other than the host vehicle 10. The other vehicle 20 may be a vehicle controlled by a driver of the other vehicle 20. Further, the other vehicle 20 may be a vehicle having its own autonomous traveling function.

The travel control device 100 is a device that controls traveling of the host vehicle 10. The travel control device 100 includes a processor 110, a main storage unit 120, an auxiliary storage unit 130, and a computer having an inter-vehicle communication interface (inter-vehicle communication I/F) 140. The processor 110 may be, for example, a central processing unit (CPU) or a digital signal processor (DSP). The main storage unit 120 may be, for example, a random access memory (RAM). The auxiliary storage unit 130 may be, for example, a read only memory (ROM). The auxiliary storage unit 130 may be, for example, a hard disk drive (HDD), or alternatively, a disc recording medium such as a CD-ROM, a DVD, or a Blu-ray Disc. Further, the auxiliary storage unit 130 may be a removable medium (portable storage medium). Examples of the removable medium include a USB memory or an SD card. The inter-vehicle communication I/F 140 is an interface communicating with a wireless communication device provided in a vehicle traveling around the host vehicle 10 to establish the inter-vehicle communication with such a vehicle. The inter-vehicle communication I/F 140 may be, for example, a wireless communication circuit used in wireless communication.

In the travel control device 100, the auxiliary storage unit 130 stores an operating system (OS), various programs, various information tables, and the like. Further, in the travel control device 100, the processor 110 can implement various functions described below by loading programs stored in the auxiliary storage unit 130 into the main storage unit 120, and executing those programs. Some or all of the functions of the travel control device 100 may be implemented by a hardware circuit such as ASIC or FPGA. Moreover, the travel control device 100 does not have to be implemented by a single physical configuration, and may be configured by a plurality of computers that cooperate with each other. The in-vehicle device 200 mounted on the other vehicle 20 is also configured by including a computer, similar to the travel control device 100.

System Configuration

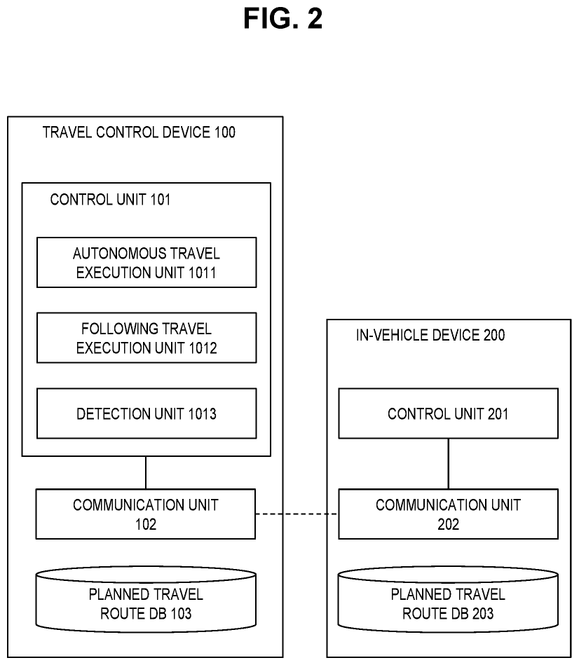

Functional configurations of the travel control device 100 and the in-vehicle device 200, constituting the travel control system 1, will be described referring to FIG. 2. FIG. 2 is a block diagram schematically illustrating one example of the functional configurations of the travel control device 100 and the in-vehicle device 200, constituting the travel control system 1 according to the present embodiment.

In-Vehicle Device

The in-vehicle device 200 mounted on the other vehicle 20 is a device that manages a planned travel route of the other vehicle 20. A car navigation system provided in the other vehicle 20 can be exemplified as the in-vehicle device 200. The in-vehicle device 200 is configured by including a control unit 201, a communication unit 202, and a planned travel route database (planned travel route DB) 203. The control unit 201 has a function of executing an arithmetic process required for controlling the in-vehicle device 200. The control unit 201 can be implemented by a processor provided in the in-vehicle device 200.

The planned travel route DB 203 stores route information including the planned travel route, which is a route planned to be traveled by the other vehicle 20 provided with the in-vehicle device 200. The planned travel route DB 203 can be implemented by an auxiliary storage unit provided in the in-vehicle device 200. The communication unit 202 has a function of establishing the inter-vehicle communication with the host vehicle 10 by communicating with the travel control device 100. The communication unit 202 can be implemented by an inter-vehicle communication OF provided in the in-vehicle device 200. The control unit 201 transmits the route information of the other vehicle 20 stored in the planned travel route DB 203 to the travel control device 100 of the host vehicle 10 via the communication unit 202.

Travel Control Device

The travel control device 100 mounted on the host vehicle 10 is configured by including a control unit 101, a communication unit 102, and a planned travel route database (planned travel route DB) 103. The communication unit 102 has a function of establishing the inter-vehicle communication with the other vehicle 20 by communicating with the in-vehicle device 200 provided in the other vehicle 20. The communication unit 102 can be implemented by the inter-vehicle communication OF 140.

The planned travel route DB 103 is a database that stores the route information of the other vehicle 20 received from the in-vehicle device 200. Further, route information of the host vehicle 10 is also stored in the planned travel route DB 103. The planned travel route DB 103 can be implemented by the auxiliary storage unit 130.

The control unit 101 has a function of executing an arithmetic process required for controlling the host vehicle 10. The control unit 101 can be implemented by the processor 110. The control unit 101 includes an autonomous travel execution unit 1011, a following travel execution unit 1012, and a detection unit 1013 as functional modules.

The following travel execution unit 1012 executes a process required for the host vehicle 10 to autonomously follow the leading vehicle. When the host vehicle 10 autonomously follows the leading vehicle by the following traveling function, the following travel execution unit 1012 detects a location of the leading vehicle based on information on a situation around the host vehicle 10, which is acquired by a sensor installed in the host vehicle 10. A stereo camera, a laser scanner, a LIDAR, or a millimeter wave radar can be exemplified as the sensor. At this time, the following travel execution unit 1012 tracks the detected leading vehicle. In this case, for example, a relative velocity of the leading vehicle can be obtained from a difference between previous coordinates of the leading vehicle detected one step before and current coordinates of the leading vehicle. Consequently, the following travel execution unit 1012 can confirm the location of the leading vehicle and the relative velocity of the leading vehicle. The following travel execution unit 1012 causes the host vehicle 10 to autonomously follow the leading vehicle while the inter-vehicle distance between the host vehicle 10 and the leading vehicle is maintained based on the location and the relative velocity of the leading vehicle.

The autonomous travel execution unit 1011 executes a process required for the host vehicle 10 to autonomously travel. When the host vehicle 10 travels by the autonomous traveling function, the autonomous travel execution unit 1011 detects, by the sensor, an object, for example, a vehicle (or persons and animals) around the host vehicle 10. At this time, the autonomous travel execution unit 1011 tracks the detected object. Further, the autonomous travel execution unit 1011 detects, by the sensor, various objects required for the autonomous travel of the host vehicle 10 including the number and locations of lanes on the road, a structure of the road, or road signs. At this time, the autonomous travel execution unit 1011 generates information on the situation around the host vehicle 10 based on the objects detected by the sensor and various objects required for the autonomous travel of the host vehicle 10. The autonomous travel execution unit 1011 controls the autonomous travel of the host vehicle 10 based on a planned travel route of the host vehicle 10, a current location of the host vehicle 10 acquired by, for example, a GPS device provided in the host vehicle 10, and the information on the situation around the host vehicle 10.

As described above, the following travel execution unit 1012 provided in the control unit 101 processes information on the location and relative velocity of the leading vehicle when the host vehicle 10 autonomously follows the leading vehicle. On the other hand, when the host vehicle 10 autonomously travels, the autonomous travel execution unit 1011 provided in the control unit 101 processes information on the planned travel route and the current location of the host vehicle 10, and the situation around the host vehicle 10. As described above, in a case where the host vehicle 10 autonomously travels, a larger amount of information is required to be processed than when the host vehicle 10 autonomously follows the leading vehicle. Consequently, the arithmetic load in the control unit 101 for enabling the host vehicle 10 to autonomously travel is larger than when enabling the host vehicle 10 to autonomously follow the leading vehicle. Accordingly, in a case where another vehicle 20 is present around the host vehicle 10 which the host vehicle 10 can autonomously follow as the leading vehicle, the control unit 101 causes the host vehicle 10 to prioritize traveling using the following traveling function over the autonomous traveling function.

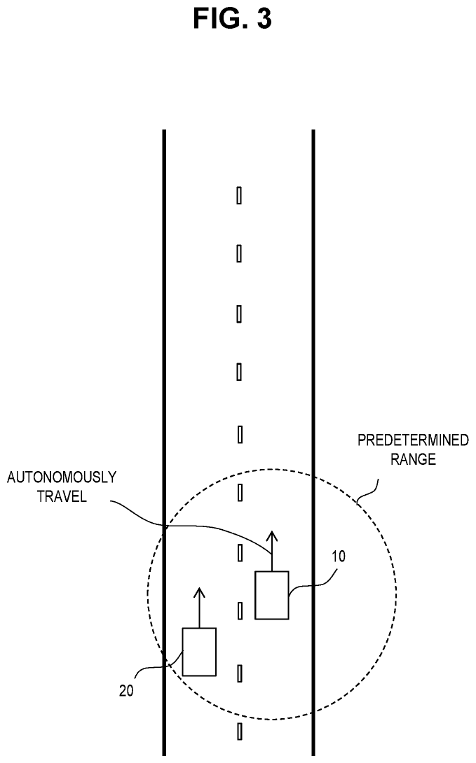

The control unit 101 receives the route information of the other vehicle 20 from the in-vehicle device 200 provided in the other vehicle 20 which is present within a predetermined range of the host vehicle 10, via the communication unit 102. FIG. 3 is a diagram illustrating one example of a situation in which the host vehicle 10 and the other vehicle 20 are traveling. At this time, the host vehicle 10 is traveling by the autonomous traveling function. As shown in FIG. 3, the other vehicle 20 is traveling within the predetermined range of the host vehicle 10. In such a case, in the travel control device 100 of the host vehicle 10, the control unit 101 receives the route information of the other vehicle 20 from the in-vehicle device 200 provided in the other vehicle 20 by the inter-vehicle communication via the communication unit 102. At this time, when a plurality of the other vehicles 20 is present within the predetermined range, the control unit 101 receives the route information of each of the other vehicles 20. The control unit 101 stores the route information of the other vehicle 20 in the planned travel route DB 103.

The detection unit 1013 detects the other vehicle 20 of which any part or all of the planned travel route is partially or wholly the same as the planned travel route of the host vehicle 10, based on the route information of the other vehicle(s) 20 and the route information of the host vehicle 10 stored in the planned travel route DB 103. In particular, the detection unit 1013 determines whether any part or all of the planned travel route of each other vehicle 20 (i.e. the other vehicles 20 present within the predetermined range of the host vehicle 10), of which the route information is stored in the planned travel route DB 103, is partially or wholly the same as the planned travel route of the host vehicle 10. Accordingly, the detection unit 1013 detects another vehicle 20 that is present within the predetermined range of the host vehicle 10 and of which any part or all of the planned travel route is partially or wholly the same as the planned travel route of the host vehicle 10. The control unit 101 switches the traveling function of the host vehicle 10 from the autonomous traveling function to the following traveling function such that the vehicle autonomously follows the other vehicle 20 detected by the detection unit 1013 as the leading vehicle.

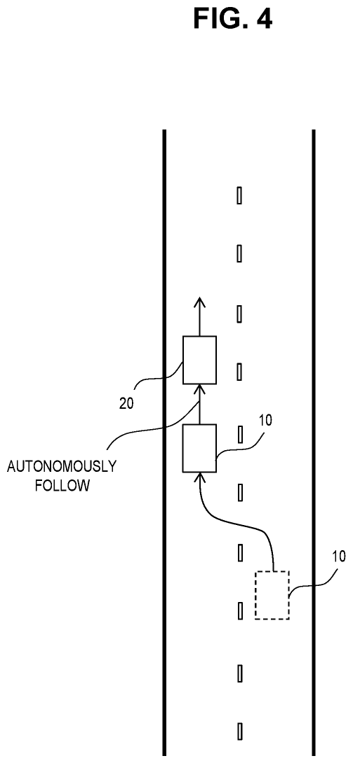

FIG. 4 is a diagram illustrating one example of a state in which the traveling function of the host vehicle 10 traveling by the autonomous traveling function is switched to the autonomous following function with the other vehicle 20 as the leading vehicle. In FIG. 4, it is assumed that any part or all of the planned travel route of the other vehicle 20 is partially or wholly the same as the planned travel route of the host vehicle 10 in the example shown in FIG. 3. In this case, as shown in FIG. 4, the host vehicle 10 travels by the autonomous traveling function to a location where it can autonomously follow the other vehicle 20. The traveling function of the host vehicle 10 is switched from the autonomous traveling function to the following traveling function such that the vehicle autonomously follows the other vehicle 20 detected as the leading vehicle. Consequently, the host vehicle 10 autonomously follows the other vehicle 20 detected by the detection unit 1013 as the leading vehicle, by the following traveling function.

First Switching Process

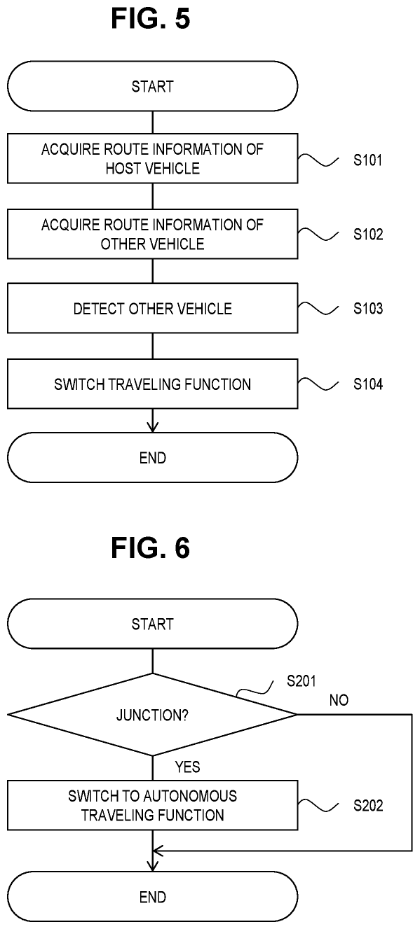

A first switching process executed by the control unit 101 provided in the travel control device 100 will be described referring to FIG. 5. FIG. 5 is a flowchart of the first switching process. The first switching process is executed when the host vehicle 10 is traveling by the autonomous traveling function. The first switching process is a process by which the traveling function of the host vehicle 10 is switched from the autonomous traveling function to the following traveling function and then the host vehicle 10 autonomously follows the other vehicle 20 as the leading vehicle.

In the first switching process, the route information of the host vehicle 10 stored in the planned travel route DB 103 is acquired in S101. The route information of the other vehicle(s) 20 stored in the planned travel route DB 103 is acquired in S102. In S103 the other vehicle 20 which is present within the predetermined range of the host vehicle 10 and of which any part or all of the planned travel route is partially or wholly the same as the planned travel route of the host vehicle 10 is detected based on the acquired route information of the host vehicle 10 and the other vehicle 20. In S104, the host vehicle 10 travels by the autonomous traveling function to a location where it can autonomously follow the other vehicle 20 detected in S103 as the leading vehicle, and then the traveling function of the host vehicle 10 is switched from the autonomous traveling function to the following traveling function such that the vehicle autonomously follows the other vehicle 20 as the leading vehicle. Consequently, the host vehicle 10 autonomously follows the other vehicle 20 detected in S103 as the leading vehicle. In a case where no other vehicle 20 of which any part or all of the planned travel route is partially or wholly the same as the planned travel route of the host vehicle 10 is detected in S103, the host vehicle 10 continues to autonomously travel.

Second Switching Process

Any part of the planned travel route of the host vehicle 10 can be partially or wholly the same as the planned travel route of the other vehicle 20 that the host vehicle 10 autonomously follows as the leading vehicle. In this case, the host vehicle 10 that autonomously follows the other vehicle 20 is required to travel by the autonomous traveling function on a travel route different from that of the other vehicle 20. Therefore, when the host vehicle 10 reaches a point (hereinafter may be referred to as a “junction”) where the planned travel route of the host vehicle 10 deviates from the planned travel route of the other vehicle 20, a second switching process is executed by which the traveling function of the host vehicle 10 is switched from the following traveling function to the autonomous traveling function and then the host vehicle 10 autonomously travels along the planned travel route of the host vehicle 10.

The second switching process executed by the control unit 101 provided in the travel control device 100 will be described referring to FIG. 6. FIG. 6 is a flowchart of the second switching process. The second switching process is periodically executed when the host vehicle 10 autonomously follows the other vehicle 20 as the leading vehicle, in which any part or all of the planned travel route of the other vehicle 20 is partially the same as the planned travel route of the host vehicle 10.

In the second switching process, it is determined, in S201, whether the current location of the host vehicle 10 is the junction. In a case where it is determined “NO” in S201, the second switching process is terminated because the host vehicle 10 has not reached the junction. That is, the host vehicle 10 remains autonomously following the other vehicle 20 as the leading vehicle. Further, in a case where it is determined “YES” in S201, since the host vehicle 10 has reached the junction, the traveling function of the host vehicle 10 is switched from the following traveling function to the autonomous traveling function in S202, and the second switching process is terminated. Consequently, the host vehicle 10 starts traveling by the autonomous traveling function. When the host vehicle 10 starts traveling by the autonomous traveling function, the control unit 101 again receives the route information of another vehicle 20 present within the predetermined range of the host vehicle 10. The control unit 101 executes the first switching process again. Accordingly, the host vehicle 10 can travel to its destination while the traveling function of the host vehicle 10 is repeatedly switched between the autonomous traveling function and the following traveling function.

As described above, in a case where another vehicle 20 is present around the host vehicle 10 which the host vehicle 10 can autonomously follow as the leading vehicle, it is possible to prioritize the vehicle traveling using the following traveling function over the autonomous traveling function, by the travel control system 1. Consequently, it is possible to reduce the arithmetic load for traveling of the host vehicle 10 in the travel control device 100.

### Modified Example

In the present embodiment, the travel control device 100 provided in the host vehicle 10 receives the route information of another vehicle 20 present within the predetermined range of the host vehicle 10 from the in-vehicle device 200 provided in the other vehicle 20 via the inter-vehicle communication. However, the travel control device 100 may receive the route information of the other vehicle 20 from a server device instead of the in-vehicle device 200. In this case, the server device receives the route information of the other vehicle 20 and the current location of the other vehicle 20 from the in-vehicle device 200. Further, the server device receives the current location of the host vehicle 10 from the travel control device 100. Consequently, the server device can confirm whether another vehicle 20 is present within the predetermined range of the host vehicle 10, based on the current location of the host vehicle 10 and the current location of the other vehicle 20. When the server device receives a request from the travel control device 100, the server device transmits the route information of the other vehicle 20 that is present within the predetermined range of the host vehicle 10 to the travel control device 100. The detection unit 1013 of the travel control device 100 detects the other vehicle 20 of which any part or all of the planned travel route is partially or wholly the same as the planned travel route of the host vehicle 10, based on the route information of the other vehicle 20 received from the server device.

A plurality of other vehicles 20 in which any part or all of the planned travel route is partially or wholly the same as the planned travel route of the host vehicle 10 may be present within the predetermined range of the host vehicle 10. In the present embodiment, the travel control device 100 provided in the host vehicle 10 receives the route information of the other vehicles 20 present within the predetermined range of the host vehicle 10 from the in-vehicle device 200 provided in the other vehicle 20 via the inter-vehicle communication. The travel control device 100 may select, from among the plurality of other vehicles 20, the other vehicle 20 in which a planned travel route overlaps with the planned travel route of the host vehicle 10 for a longer distance, as the leading vehicle. It is possible to shorten a period during which the host vehicle 10 travels by the autonomous traveling function by autonomously following another vehicle 20, as the leading vehicle, in which the planned travel route overlaps with the planned travel route of the host vehicle 10 for a longer distance. Consequently, it is possible to reduce the arithmetic load for traveling of the host vehicle 10 in the control unit 101.

### Second Embodiment

In a second embodiment, a management server detects another vehicle 20 that is present within the predetermined range of the host vehicle 10 and of which any part or all of the planned travel route is partially or wholly the same as the planned travel route of the host vehicle 10. Further, the management server executes a process for instructing the host vehicle 10 to autonomously follow the other vehicle 20 detected as the leading vehicle. Hereinafter, only features different from the first embodiment will be described.

Outline of System

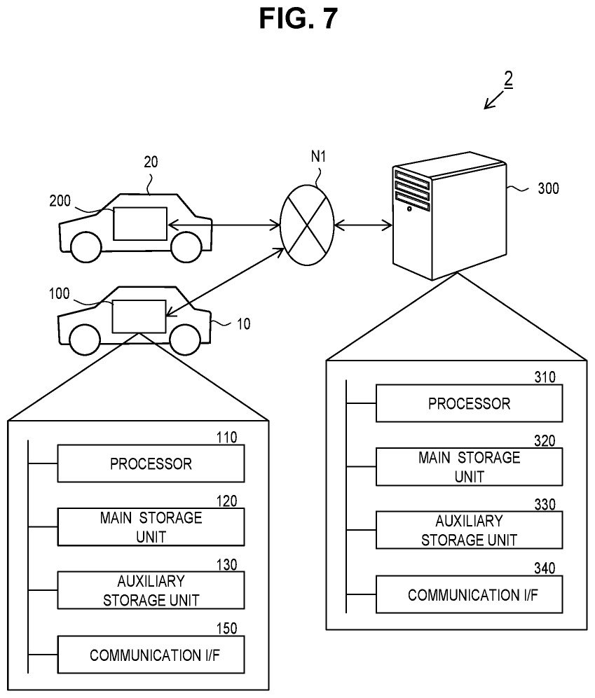

A travel control system 2 of the present embodiment will be described hereinbelow referring to FIG. 7. FIG. 7 is a diagram illustrating a schematic configuration of the travel control system 2 according to the present embodiment. The travel control system 2 is configured by including the travel control device 100, the in-vehicle device 200, and a management server 300. In the travel control system 2, the travel control device 100, the in-vehicle device 200, and the management server 300 are connected to each other by a network N1. The network N1 may be, for example, a worldwide public communication network such as Internet or the like, and a WAN (Wide Area Network) or a telecommunications network such as a cellular network. The management server 300 of the present embodiment corresponds to the “information processing apparatus” according to the second aspect of the present disclosure.

In the present embodiment, the travel control device 100 includes a communication interface (communication I/F) 150 instead of the inter-vehicle communication I/F 140 in the first embodiment. The communication I/F 150 is an interface configured to allow the in-vehicle device 200 to access the network N1. The communication I/F 150 may be, for example, a communication circuit used in wireless communication. The in-vehicle device 200 is also configured by including a computer, similar to the travel control device 100.

Further, the management server 300 is a server that manages the planned travel routes of the host vehicle 10 and the other vehicle 20. A processor 310, a main storage unit 320, and an auxiliary storage unit 330 of the management server 300 are the same as the processor 110, the main storage unit 120, and the auxiliary storage unit 130 of the travel control device 100, respectively. A communication I/F 340 provided in the management server 300 is an interface configured to allow the management server 300 to access the network N1. The communication I/F 340 may be for example, a LAN (Local Area Network) interface board or a wireless communication circuit for wireless communication.

System Configuration

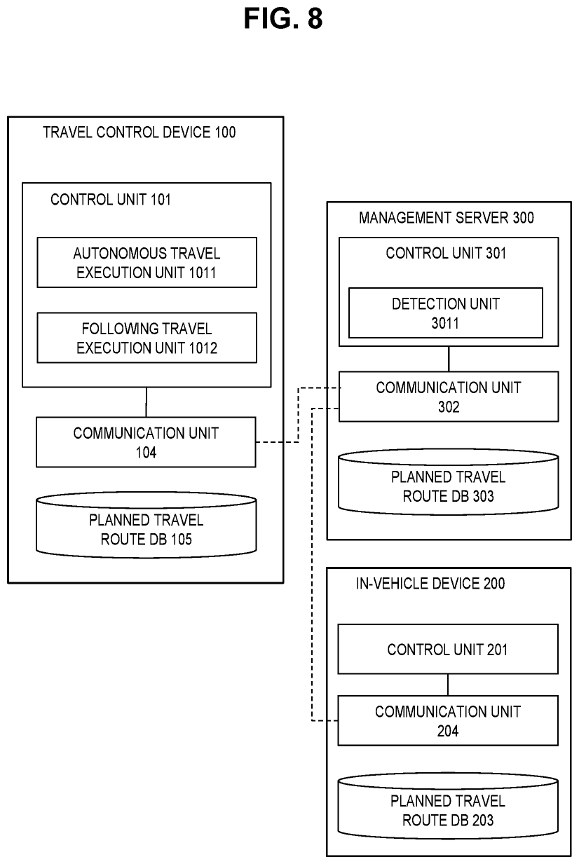

Functional configurations of the travel control device 100, the in-vehicle device 200 and the management server 300, constituting the travel control system 2, will be described referring to FIG. 8. FIG. 8 is a block diagram schematically illustrating one example of the functional configurations of the travel control device 100, the in-vehicle device 200 and the management server 300, constituting the travel control system 2 according to the present embodiment.

In-Vehicle Device

In the present embodiment, the in-vehicle device 200 includes a communication unit 204 instead of the communication unit 202 in the first embodiment. The communication unit 204 has a function of connecting the in-vehicle device 200 to the network N1. The communication unit 204 can be implemented by a communication I/F provided in the in-vehicle device 200. The control unit 201 transmits the route information of the other vehicle 20 stored in the planned travel route DB 203, together with the current location of the other vehicle 20, to the management server 300 via the communication unit 204.

Travel Control Device

In the present embodiment, the travel control device 100 includes a communication unit 104 instead of the communication unit 102 in the first embodiment. The communication unit 104 has a function of connecting the travel control device 100 to the network N1. The communication unit 104 can be implemented by the communication I/F 150. Further, the route information of the host vehicle 10 is stored in a planned travel route DB 105. The planned travel route DB 105 can be implemented by the auxiliary storage unit 130. The control unit 101 transmits the route information of the host vehicle 10 stored in the planned travel route DB 105, together with the current location of the host vehicle 10, to the management server 300 via the communication unit 104. The control unit 101 receives first command information from the management server 300 via the communication unit 104 when the host vehicle 10 is traveling by the autonomous traveling function. The first command information is information for instructing the travel control device 100 to switch the traveling function of the host vehicle 10 from the autonomous traveling function to the following traveling function such that the host vehicle 10 autonomously follows the other vehicle 20 as the leading vehicle.

The control unit 101 includes the autonomous travel execution unit 1011 and the following travel execution unit 1012 as functional modules. The control unit 101 switches, when the first command information is received from the management server 300, the traveling function of the host vehicle 10 from the autonomous traveling function to the following traveling function.

Management Server

The management server 300 is a server that manages the current locations and the route information of the host vehicle 10 and the other vehicle 20. The management server 300 is configured by including a control unit 301, a communication unit 302, and a planned travel route DB 303.

The communication unit 302 has a function of connecting the management server 300 to the network N1. The communication unit 302 can be implemented by the communication I/F 340. The control unit 301 has a function of executing an arithmetic process required for controlling the management server 300. The control unit 301 can be implemented by the processor 310. The control unit 301 includes a detection unit 3011 as a functional module.

The planned travel route DB 303 is a database that stores the current location and the route information of the host vehicle 10, as well as the current location and the route information of the other vehicle 20. The planned travel route DB 303 can be implemented by the auxiliary storage unit 330. The control unit 301 receives the current location and the route information of the host vehicle 10 from the travel control device 100 via the communication unit 302. The control unit 301 receives the current location and the route information of the other vehicle 20 from the in-vehicle device 200 via the communication unit 302. The control unit 301 stores the current locations and route information of the host vehicle 10 and the other vehicle 20 in the planned travel route DB 303 as received.

The detection unit 3011 acquires the route information of the other vehicle(s) 20 present within the predetermined range of the host vehicle 10, based on the current locations of the host vehicle 10 and the other vehicle(s) 20 stored in the planned travel route DB 303. The detection unit 3011 detects the other vehicle 20 of which any part or all of the planned travel route is partially or wholly the same as the planned travel route of the host vehicle 10, based on the route information of the other vehicle(s) 20 and the route information of the host vehicle 10 stored in the planned travel route DB 303. At this time, the detection unit 3011 detects the other vehicle 20 of which any part or all of the planned travel route is partially or wholly the same as the planned travel route of the host vehicle 10, in the same manner as that of the detection unit 1013 of the travel control device 100 in the first embodiment. Accordingly, the detection unit 3011 detects the other vehicle 20 that is present within the predetermined range of the host vehicle 10 and of which any part or all of the planned travel route is partially or wholly the same as the planned travel route of the host vehicle 10.

First Command Process

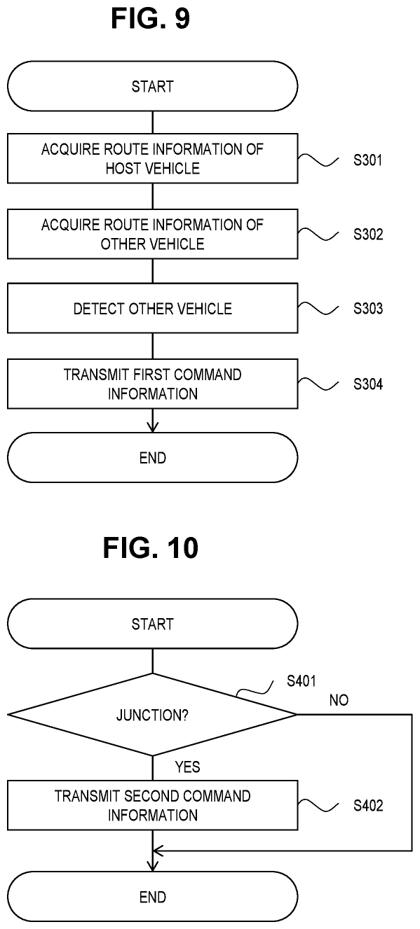

A first command process executed by the control unit 301 provided in the management server 300 will be described referring to FIG. 9. FIG. 9 is a flowchart of the first command process. The first command process is a process required for transmitting the first command information to the travel control device 100. The first command process is executed when the host vehicle 10 is traveling by the autonomous traveling function. Information indicating that the host vehicle 10 is traveling by the autonomous traveling function may be transmitted from the travel control device 100 of the host vehicle 10 to the management server 300.

In the first command process, the route information of the host vehicle 10 stored in the planned travel route DB 303 is acquired in S301. In S302, the route information of the other vehicle(s) 20, present within the predetermined range of the host vehicle 10, is acquired from the planned travel route DB 303, based on the current locations of the host vehicle 10 and the other vehicle(s) 20 stored in the planned travel route DB 303. In S303, the other vehicle 20 is detected which is present within the predetermined range of the host vehicle 10 and of which any part or all of the planned travel route is partially or wholly the same as the planned travel route of the host vehicle 10, based on the acquired route information of the host vehicle 10 and the other vehicle 20. In S304, the first command information is transmitted to the travel control device 100 of the host vehicle 10 such that the host vehicle 10 autonomously follows the other vehicle 20 detected in S303.

The travel control device 100 of the host vehicle 10 switches, when the first command information is received from the management server 300, the traveling function of the host vehicle 10 from the autonomous traveling function to the following traveling function. At this time, the travel control device 100 causes the host vehicle 10 to travel by the autonomous traveling function to a location where it can autonomously follow the other vehicle 20 detected in S303 of the first command process shown in FIG. 9 as the leading vehicle, and then switches the traveling function of the host vehicle 10 from the autonomous traveling function to the following traveling function. In a case where no other vehicle 20 of which any part or all of the planned travel route is partially or wholly the same as the planned travel route of the host vehicle 10 is detected in S303 of the first command process shown in FIG. 9, the first command information is not transmitted from the management server 300. Therefore, the host vehicle 10 continues to autonomously travel.

Second Command Process

Further, the management server 300 transmits, when the host vehicle 10 autonomously follows the other vehicle 20 as the leading vehicle by the following traveling function and reaches the junction, second command information for instructing the travel control device 100 to switch the traveling function of the host vehicle 10 from the following traveling function to the autonomous traveling function such that the host vehicle 10 autonomously travels.

A second command process executed by the control unit 301 provided in the management server 300 will be described referring to FIG. 10. FIG. 10 is a flowchart of the second command process. The second command process is a process required for transmitting the second command information from the management server 300 to the travel control device 100. The second command process is periodically executed when the host vehicle 10 travels by the following traveling function after the first command process is executed.

In the second command process, it is determined whether the current location of the host vehicle 10 is the junction based on the current location of the host vehicle 10 stored in the planned travel route DB 303 in S401. In a case where it is determined “NO” in S401, the second command process is terminated because the host vehicle 10 has not reached the junction. That is, the second command information is not transmitted from the management server 300. In this case, the host vehicle 10 continues to autonomously follow the other vehicle 20 as the leading vehicle. Further, in a case where it is determined “YES” in S401, since the host vehicle 10 has reached the junction, the second command information is transmitted and the second command process is terminated in S402. The control unit 101 provided in the travel control device 100 switches, when the second command information is received from the management server 300, the traveling function of the host vehicle 10 from the following traveling function to the autonomous traveling function.

As described above, it is also possible to reduce the arithmetic load for traveling of the host vehicle 10 in the travel control device 100 with the travel control system 2 according to the present embodiment.

### Modified Example

Similar to the travel control device 100 according to the modified example of the first embodiment, the management server 300 may select, from among a plurality of other vehicles 20, in a case where there is the plurality of other vehicles 20 within the predetermined range of the host vehicle 10 and any part or all of a planned travel route of each of the other vehicles is partially or wholly the same as a planned travel route of the host vehicle 10, the other vehicle 20 in which the planned travel route overlaps with the planned travel route of the host vehicle 10 for a longer distance as the leading vehicle that the host vehicle 10 autonomously follows.

### Other Embodiments

The embodiments stated above are mere examples, and the present disclosure can be implemented with appropriate modifications within a scope not departing from the gist thereof. Moreover, the processes and units described in the present disclosure can be freely combined and implemented unless technical contradiction occurs.

Further, the process described as being performed by a single device may be executed in a shared manner by a plurality of devices. Alternatively, the process described as being performed by different devices may be executed by a single device. In the computer system, the hardware configuration (server configuration) for implementing various functions can be flexibly changed.

The present disclosure can also be implemented by supplying a computer program for executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage medium include a random disk (such as a magnetic disk (Floppy® disk, hard disk drive (HDD), and the like) or an optical disc (CD-ROM, DVD disc, Blu-ray disc, and the like)), read-only memory (ROM), random access memory (RAM), EPROM, EEPROM, magnetic card, flash memory, optical card, and a random type of medium suitable for storing electronic instructions.

What is claimed is:

1. A travel control device that controls traveling of a vehicle of which a traveling function is switchable between an autonomous traveling function and a following traveling function, the travel control device comprising:
a control unit configured to:
detect, when the vehicle is traveling by the autonomous traveling function, another vehicle present within a predetermined range of the vehicle and of which any part or all of a planned travel route is partially or wholly the same as a planned travel route of the vehicle; and
switch the traveling function of the vehicle from the autonomous traveling function to the following traveling function such that the vehicle autonomously follows the detected other vehicle as a leading vehicle.

2. The travel control device according to claim 1, wherein the control unit is configured to, in a case where there is a plurality of other vehicles within the predetermined range of the vehicle, in each of which any part or all of a planned travel route is partially or wholly the same as the planned travel route of the vehicle, select, from among the plurality of other vehicles, another vehicle in which the planned travel route overlaps with the planned travel route of the vehicle for a longer distance as the leading vehicle that the vehicle autonomously follows.

3. The travel control device according to claim 1, wherein the control unit is configured to cause the vehicle to travel by the autonomous traveling function to a location where the vehicle is able to autonomously follow the detected other vehicle as the leading vehicle, and then to switch the traveling function of the vehicle from the autonomous traveling function to the following traveling function.

4. The travel control device according to claim 1, wherein the control unit is configured to, when the vehicle autonomously follows the other vehicle as the leading vehicle by the following traveling function and reaches a junction at which the planned travel route of the vehicle deviates from the planned travel route of the other vehicle, switch the traveling function of the vehicle from the following traveling function to the autonomous traveling function.

5. The travel control device according to claim 1, further comprising:
a database that stores route information including the planned travel route of the vehicle and route information including the planned travel route of the other vehicle,
wherein the control unit is configured to detect another vehicle of which any part or all of the planned travel route is partially or wholly the same as the planned travel route of the vehicle, based on the route information of the vehicle and the route information of the other vehicle which are stored in the database.

6. The travel control device according to claim 5, wherein the control unit is configured to:
receive the route information of the other vehicle from the other vehicle by inter-vehicle communication; and
store the received route information of the other vehicle in the database.

7. The travel control device according to claim 5, wherein the control unit is configured to:
receive the route information of the other vehicle from a server device that manages the planned travel route and a current location of the other vehicle; and
store the received route information of the other vehicle in the database.

8. An information processing apparatus that manages, using a travel control device, traveling of a vehicle of which a traveling function is switchable between an autonomous traveling function and a following traveling function, the information processing apparatus comprising:
a control unit configured to:
detect, when the vehicle is traveling by the autonomous traveling function, another vehicle present within a predetermined range of the vehicle and of which any part or all of a planned travel route is partially or wholly the same as a planned travel route of the vehicle; and
transmit, to the travel control device, first command information to command the travel control device to switch the traveling function of the vehicle from the autonomous traveling function to the following traveling function such that the vehicle autonomously follows the detected other vehicle as a leading vehicle.

9. The information processing apparatus according to claim 8, wherein the control unit is configured to, in a case where there is a plurality of other vehicles within the predetermined range of the vehicle, in each of which any part or all of a planned travel route is partially or wholly the same as the planned travel route of the vehicle, select, from among the plurality of other vehicles, another vehicle in which the planned travel route overlaps with the planned travel route of the vehicle for a longer distance as the leading vehicle that the vehicle autonomously follows.

10. The information processing apparatus according to claim 8, wherein the control unit is configured to, when the vehicle autonomously follows the other vehicle as the leading vehicle by the following traveling function and reaches a junction at which the planned travel route of the vehicle deviates from the planned travel route of the other vehicle, transmit, to the travel control device, second command information to command the travel control device to switch the traveling function of the vehicle from the following traveling function to the autonomous traveling function.

11. The information processing apparatus according to claim 8, further comprising:
a database that stores route information including the planned travel route of the vehicle and route information including the planned travel route of the other vehicle,
wherein the control unit is configured to detect the other vehicle of which any part or all of the planned travel route is partially or wholly the same as the planned travel route of the vehicle, based on the route information of the vehicle and the route information of the other vehicle which are stored in the database.

12. The information processing apparatus according to claim 11, wherein the control unit is configured to:
receive the route information of the vehicle from the vehicle;
receive the route information of the other vehicle from the other vehicle; and
store the received route information of the vehicle and the received route information of the other vehicle in the database.

13. The information processing apparatus according to claim 8, wherein the travel control device is configured to, upon receiving the first command information, switch the traveling function of the vehicle from the autonomous traveling function to the following traveling function such that the vehicle autonomously follows the detected other vehicle as the leading vehicle.

14. The information processing apparatus according to claim 13, wherein the travel control device is configured to, upon receiving the first command information, cause the vehicle to travel by the autonomous traveling function to a location where the vehicle is able to autonomously follow the detected other vehicle as the leading vehicle, and then switch the traveling function of the vehicle from the autonomous traveling function to the following traveling function.

15. The information processing apparatus according to claim 10, wherein the travel control device is configured to, upon receiving the second command information, switch the traveling function of the vehicle from the following traveling function to the autonomous traveling function.

16. An information processing method, which is executed by a computer included in a system, the system including a travel control device that controls traveling of a vehicle of which a traveling function is switchable between an autonomous traveling function and a following traveling function, the information processing method comprising:
detecting, when the vehicle is traveling by the autonomous traveling function, using the travel control device, another vehicle present within a predetermined range of the vehicle and of which any part or all of a planned travel route is partially or wholly the same as a planned travel route of the vehicle; and
switching the traveling function of the vehicle from the autonomous traveling function to the following traveling function such that the vehicle autonomously follows the detected other vehicle as a leading vehicle.

17. The information processing method according to claim 16, further comprising selecting, from among a plurality of other vehicles, in a case where there is a plurality of other vehicles within the predetermined range of the vehicle, in each of which any part or all of a planned travel route is partially or wholly the same as the planned travel route of the vehicle, another vehicle in which the planned travel route overlaps with the planned travel route of the vehicle for a longer distance as the leading vehicle that the vehicle autonomously follows.

18. The information processing method according to claim 16, wherein the vehicle is caused to travel by the autonomous traveling function to a location where the vehicle is able to autonomously follow the detected other vehicle as the leading vehicle, and then the traveling function of the vehicle is switched, using the travel control device, from the autonomous traveling function to the following traveling function.

19. The information processing method according to claim 16, further comprising switching, when the vehicle autonomously follows the other vehicle as the leading vehicle by the following traveling function and reaches a junction at which the planned travel route of the vehicle deviates from the planned travel route of the other vehicle, the traveling function of the vehicle from the following traveling function to the autonomous traveling function, using the travel control device.

20. The information processing method according to claim 16, wherein the system further includes a database that stores route information including the planned travel route of the vehicle and route information including the planned travel route of the other vehicle, and the other vehicle of which any part or all of the planned travel route is partially or wholly the same as the planned travel route of the vehicle is detected based on the route information of the vehicle and the route information of the other vehicle which are stored in the database.
